(19) United States
(12) Patent Application Publication
(10) Pub. No.: US 2016/0140579 A1
(43) Pub. Date: May 19, 2016

(54) METHOD AND APPARTUS FOR MEDIA EVENT ANALYSIS

(71) Applicant: TV Squared Limited, Edinburgh (GB)

(72) Inventors: Alan Jackson, Edinburgh (GB); Blair Robertson, Edinburgh (GB); Hew Bruce-Gardyne, Edinburgh (GB)

(21) Appl. No.: 14/790,037

(22) Filed: Jul. 2, 2015

(30) Foreign Application Priority Data
Nov. 13, 2014 (GB) 1420191.7

(51) Int. Cl. G06Q 30/02; G06F 17/30

(52) U.S. Cl. CPC G06Q 30/0201; G06F 17/30598; G06F 17/30867

(57) ABSTRACT

The invention relates to a method and apparatus for utilising data relating to one or more predetermined events which occur in at least one visual and/or audible media. The invention identifies the one or more predetermined events and collects response data from one or more user sources and allocates the collected data to response times or time intervals. At least part of the collected response data is allocated as occurring as a result of one or more of the predetermined events and other of the collected response data is not taken into account as it is identified as resulting from general activity rather than being specific to a predetermined event.

The invention to which this application relates is a processing apparatus and method which allow the success, or otherwise, of a media event such as an advertising campaign or specific advertisements, which are placed in media such as a television channel or channels, to be analysed and for the results of the analysis to be used in the ongoing attribution of media events, in the media.

The ability to identify a return or investment, from a media event, is a well-known and long lasting problem. At present, it is believed that there is no particularly reliable system or method that allows for the ability to identify whether the placement of a particular advertisement has specific effects on a person or groups of persons who have the opportunity to view and/or listen to that advert, and, in particular, whether the listening and/or viewing of the advertisement, has led to the person purchasing a product represented by the advertisement.

Response is driven by varying factors such as multiple media driving traffic, the response baseline changes constantly, econometrics are slow and coarse, some data, such as call centre data can be of less importance, coupons and URLs are flawed, and this can mean that the response curve varies by medium, overlapping predetermined event occurrences can cause inaccurate attribution and can ignore the impact of spot placement.

It is known to collate a group of viewers into a “panel” and to seek data relating to responses received from the panel of viewers, and to then attempt to use that data, as being representative of a significantly larger group, or all, viewers and/or listeners of particular media to which the information from the panel relates. However, it is typically found that the size of the panel which is created and used as the reference source is insufficient to provide data which can be used for detailed analysis to be performed and therefore the results obtained from the panel are regarded as being relatively unrepresentative and unreliable of the much larger groups which are required to be assessed. It is also known to refer to historical data in various ways but the problem with historical data is that, while it may provide indications of possible media event impact, trends and patterns, the same are not necessarily applicable on an on-going basis.

It is also known to take into account, demographic information relating to particular viewers and the potential impact of types of media events on the same, but again, this, on its own, does not provide information which can be of significant use.

Thus, the aim of the present invention is to provide a means of using data which is available in a manner so as to allow the source and cause of the data which is generated, to be identified and then used with regard to the identified media event in order to provide an indication of the impact, effectiveness of the one or more media events. A further aim is to be able to use the data which is identified in a manner so as to allow predictive decisions to be made in an accurate manner.

In a first aspect of the invention, there is provided a method of utilising data relating to one or more predetermined events which occur in at least one visual and/or audible media, said system comprising means for collecting data from one or more sources relating to one or more users, allocating the data which has been collected, to predefined times or time intervals, storing data indicating the occurrence of the predefined events in terms of any, or any combination, of time, said media location for the display of the predefined event and/or geographical accessibility of the predefined event and wherein the collected data is selectively attributed to the one or more predetermined events and processing means allow the classification of that of the collected data which is identified as not being attributable to the said predetermined event by analysis of the collected data in combination with the stored data.

In one embodiment, the processing means takes into account the time lag between the occurrence of the predetermined event, and the data potentially relating thereto being identified such that, for example, if a purchase occurs relatively quickly after the occurrence of a predetermined event then the correlation between the purchase and the predetermined event, will be stronger than that if the purchase occurs significantly litter than the predetermined event.

Typically a calculation is performed as to the probability that detected data is resultant from a predetermined event.

In one embodiment, the data relating to the predetermined events is collected and then filtered using, one or a combination of filtering techniques such as a Fourier filtering technique.

In one embodiment, a baseline calculation step is performed on the collected data to remove from consideration data which it is believed is as a result of activity by users which would occur in any case, and regardless of the occurrence of the predetermined event.

In one embodiment, a further filter step or steps is/are performed which is of a greater degree of granularity in order to allocate the collected data to a particular predetermined event from a number of the predetermined events which have occurred within a given time period.

In a further embodiment, the filtering is performed in order to identify and allocate collected data with respect to a plurality of predetermined events so that, for example, the collected data may not all be allocated to the predetermined event which occurred shortly before the occurrence of the collected data and instead some of the collected data may be allocated to one or more preceding predetermined events.

Thus, in accordance with the invention in one embodiment, the collected data that is, as a result of the invention, allocated to particular predetermined events, can be provided in a manner which indicates a strong association between the allocated data and the specific predetermined events and a stronger association than that which can be achieved in conventional systems and methods. Furthermore, that data which is collected and has a relatively low association possibility with respect to the predetermined events is disregarded and removed from consideration by the filtering processes used.

Typically the collected data is that which is received from users of a particular service on which the predetermined event is located and/or from the users who perform a particular action, such as a purchase, in association with the organisation with which the predetermined event is connected. Typically a range of sources are used to collect the data.

Thus, the use of the filtration steps and analysis of the time at which the collected data was generated allows the effectiveness of predetermined events which are particularly effective to be identified whilst, at the same time, allowing a more accurate indication of those predetermined events which are more effective than others of the predetermined adverts to be identified, and those which are less effective to be identified as only the particularly strong correlations are used in the analysis, and more general response data had a reduced influence.

In one embodiment, the geographical location from which the collected data originates is identified and, processed.

In one embodiment, the collected data is processed on a geographically regional basis in a first instance, and filtered to identify correlations between the data and the predetermined events in that region.

In one embodiment, the collected data for particular geographical regions, and the predetermined events which occurred, are combined into large geographical area collected data groups and so on until the required geographical area is reached. Typically, the type and/or granularity of the filtering steps which are performed is changed with respect to the size and/or particular geographical region or area for which the collected data is to be processed such that, for example, a relatively finer granularity of filtering for collected data for smaller geographical areas than is used in large geographical areas.

In one embodiment, the analysis takes into account known and/or identified lag in the occurrence of a predetermined event and the occurrence of a subsequent response which should be allocated to the predetermined event. In one embodiment the time lag analysis takes into account the specific brand and/or type of product and/or geographical location to which the predetermined event relates so that the filtering steps can take the lag into account to identify whether the response should be allocated to a predetermined event which occurred at a given time in advance of the detected response. In one embodiment, for predetermined events which relate to certain products or product types, the time lag may be relatively small and for other products or product types, the time lag may be relatively large.

The response data, in one embodiment can be split into direct response data, diffuse response data, which has a greater time lag, deferred response data which has a greater time lag, and brand response data which can be attributed to a brand rather than the predetermined event.

In one embodiment, the base line which is used for removing from consideration data which is indicative of general activity, is adapted in terms of any or any combination of the type of predetermined events, the time of occurrence of each predetermined event and/or earlier user responses data. For example, the base band level will be increased for a period of time in a particular day in which it is known that the demand, and hence user response, for a product to which the predetermined event relates will be higher regardless of the. predetermined event occurring or not, and so typically the baseband is continually adapted to take external criteria into account such that the effect of the predetermined event which may occur in that given period, can still be identified over and above the “normal” changes in demand which would occur in any case.

Typically the data which is collected includes any, or any combination of user purchase of a product, user selection of a particular option to access an internet site, phone access via one or more numbers, a smartphone application, physical purchase by a user, and/or a user response of an expression of interest. In each of these mechanisms, specific means can be used to narrow down the source media event which may have caused the response such as any or any combination of vanity URLs/specific landing sites used, specific phone numbers and/or the use of a coupon.

Typically the predetermined even is an advert which appears in a television or radio channel.

In a further aspect of the invention there is provided a system of utilising data relating to one or more advertising events which occur in at least one visual and/or audible media, said system comprising means for collecting data from one or more user sources and allocating the data which has been collected, to response times and/or a time interval after a particular predetermined event, storage means for the storage of said collected data and allocation data and data relating to the occurrence of the predetermined events in terms of any, or any combination, of time, said media location for the display of the predefined event and/or geographical accessibility and wherein processing means are provided to attribute that collected data which can be attributed to one or more predefined events and said processing means include filtering means to remove collected data which is not attributable to said advertising event.

In a yet further aspect of the invention there is provided apparatus for utilising data relating to one or more predetermined events which occur in at least one visual and/or audible media, said apparatus including communication means to receive data relating to the said predetermined events from a plurality of user sources, processing means which allocate, with reference to at least one parameter of the said collected data, the collected data to response times and/or a time interval after a particular predetermined event, storage means for the storage of said collected and allocation data and for data relating to one or more predetermined events in relation to any, or any combination, of, time of the predetermined event, the location of the display of the predetermined event in said media and/or the geographical accessibility of the predetermined event and wherein the processing means attributes at least part of the collected data to a particular one of the one or more predetermined events and filtering means are provided to remove collected data which is not attributed to said predetermined event.

Typically the predetermined event is an advert for a particular product or service.

Specific embodiments of the invention are now described with reference to the accompanying drawings;

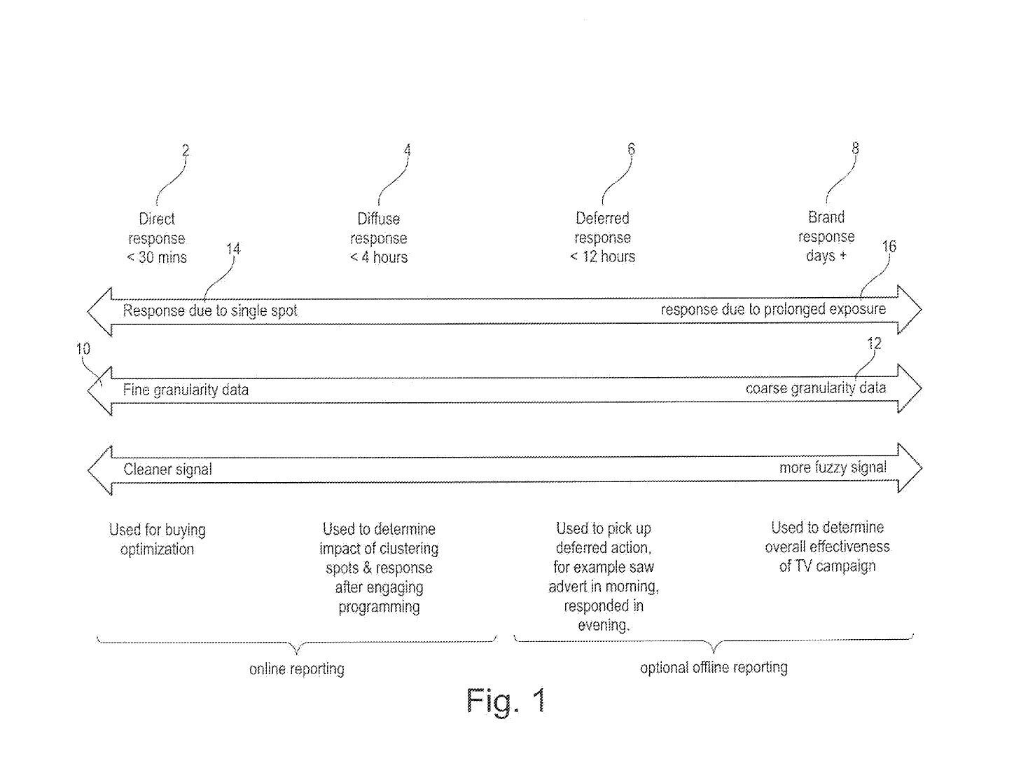

FIG. 1 illustrates the manner in which collected data can be attributed in accordance with one embodiment of the invention;

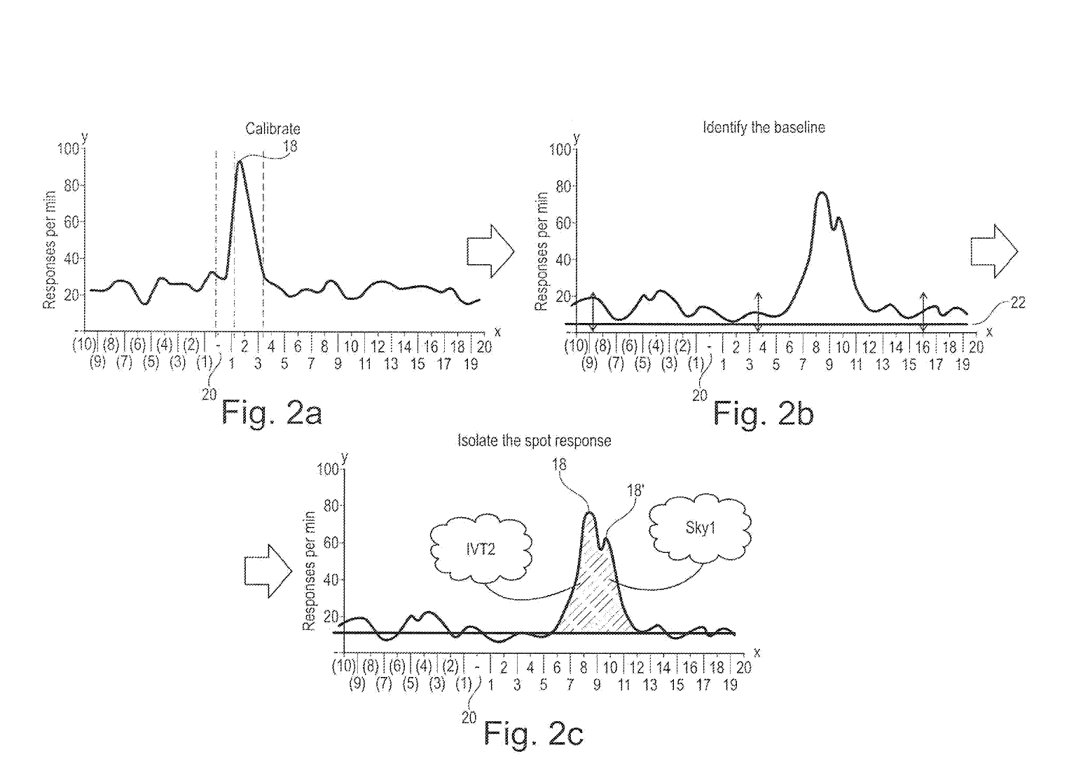

FIG. 2 illustrates the manner in which data can be processed in accordance with one embodiment of the invention;

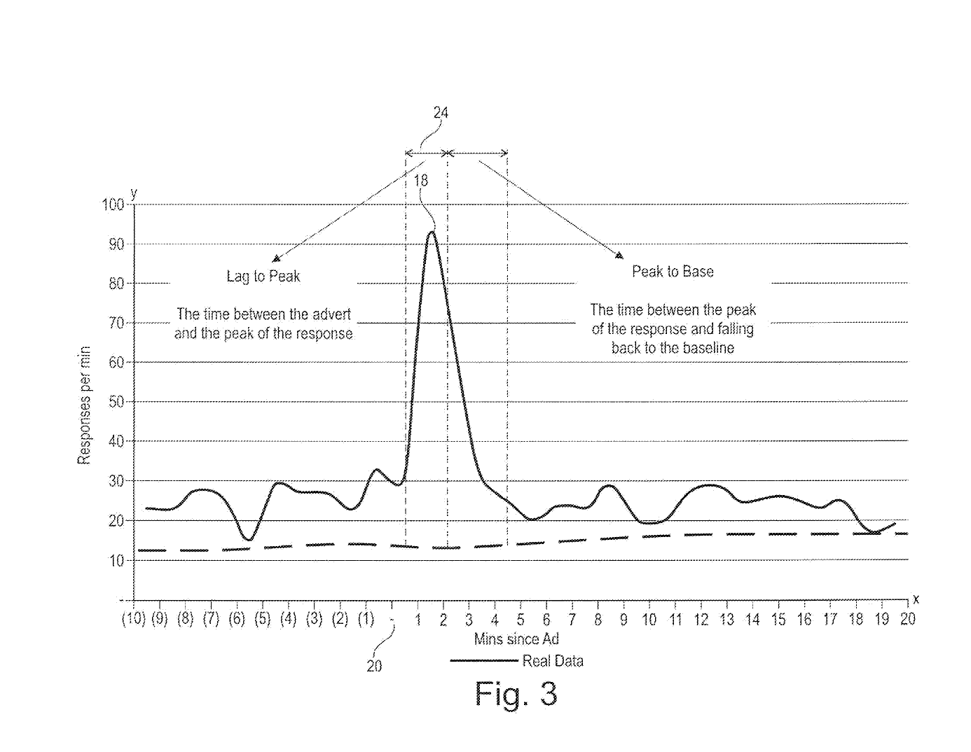

FIGS. 3-6 describe the embodiment of the invention of FIG. 2 in greater detail;

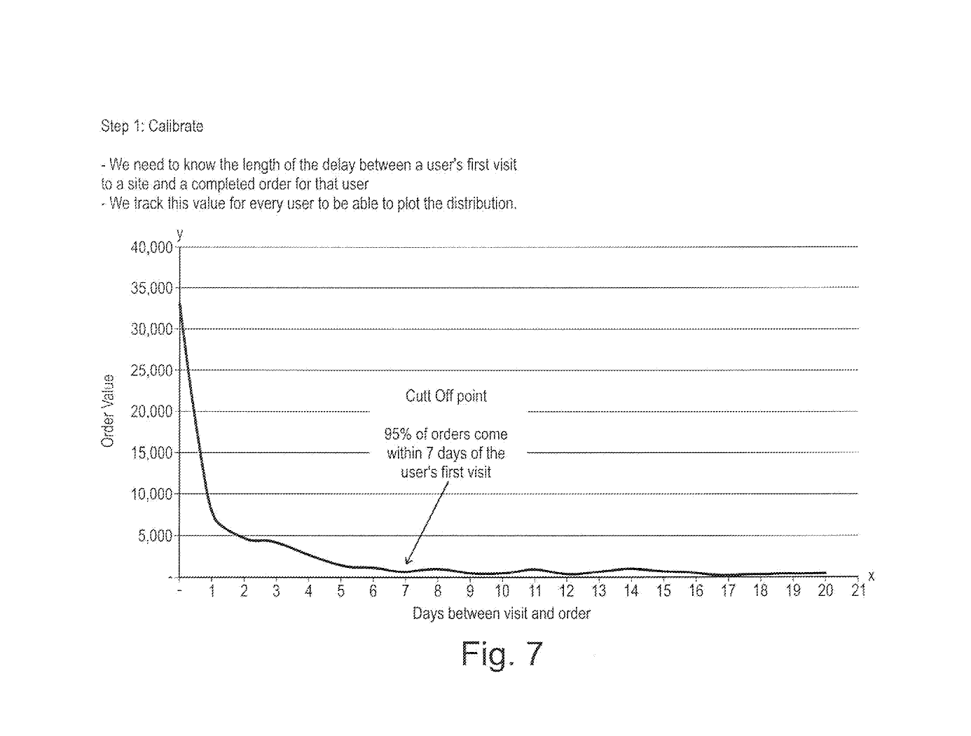

FIGS. 7-9 illustrate method steps for attributing orders delay from advertising events; and

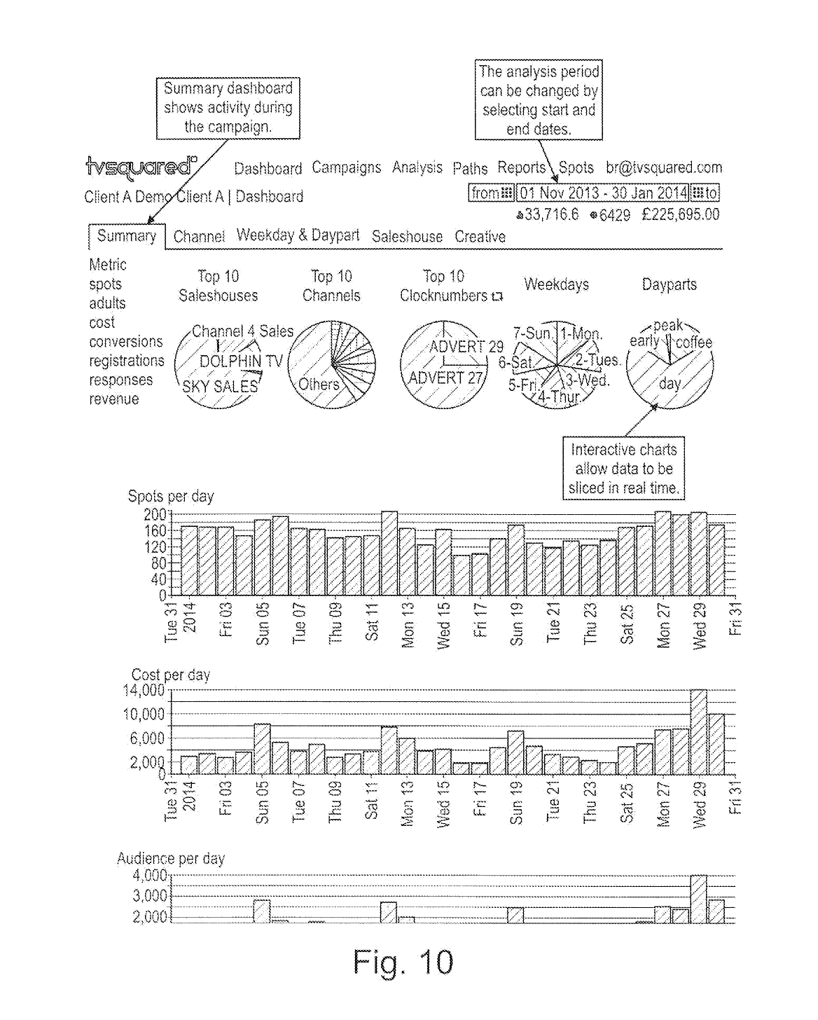

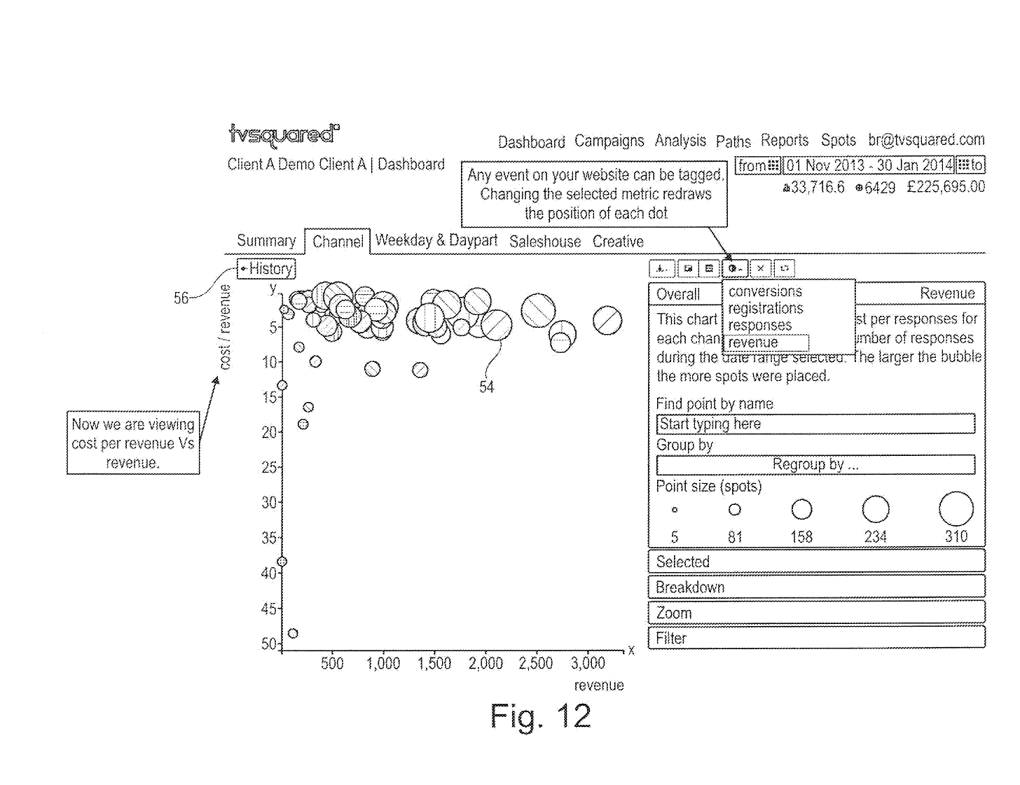

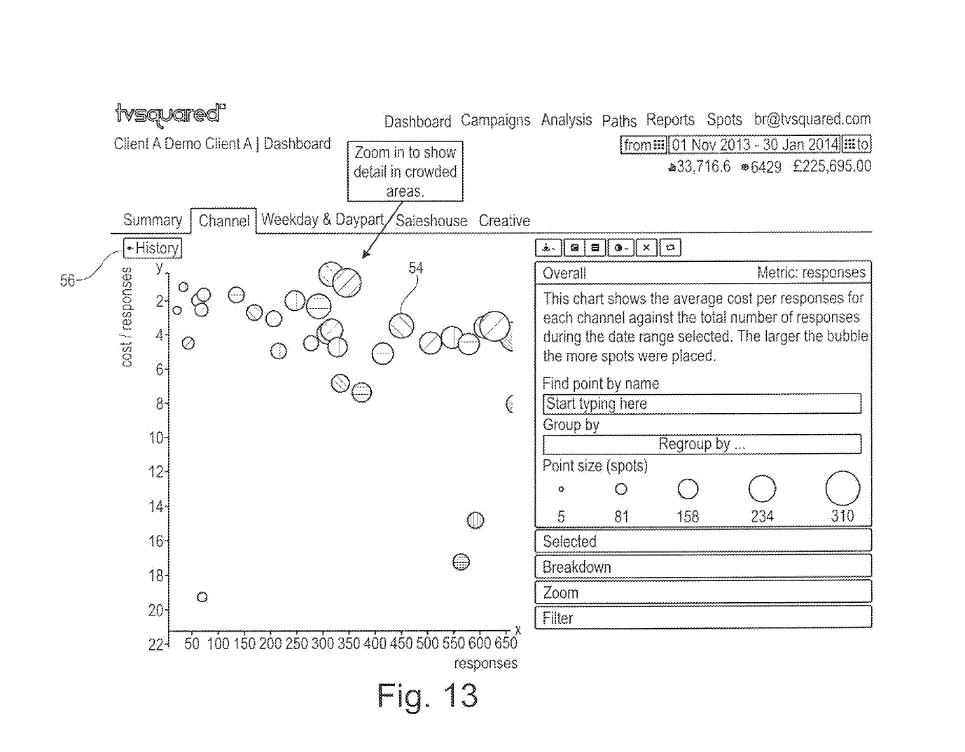

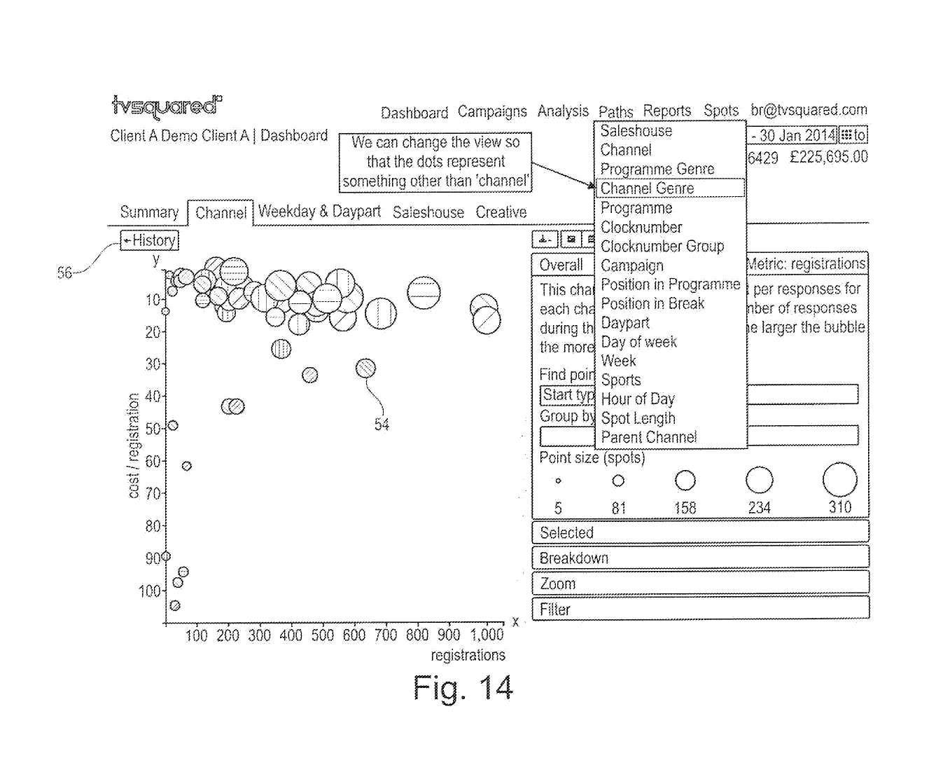

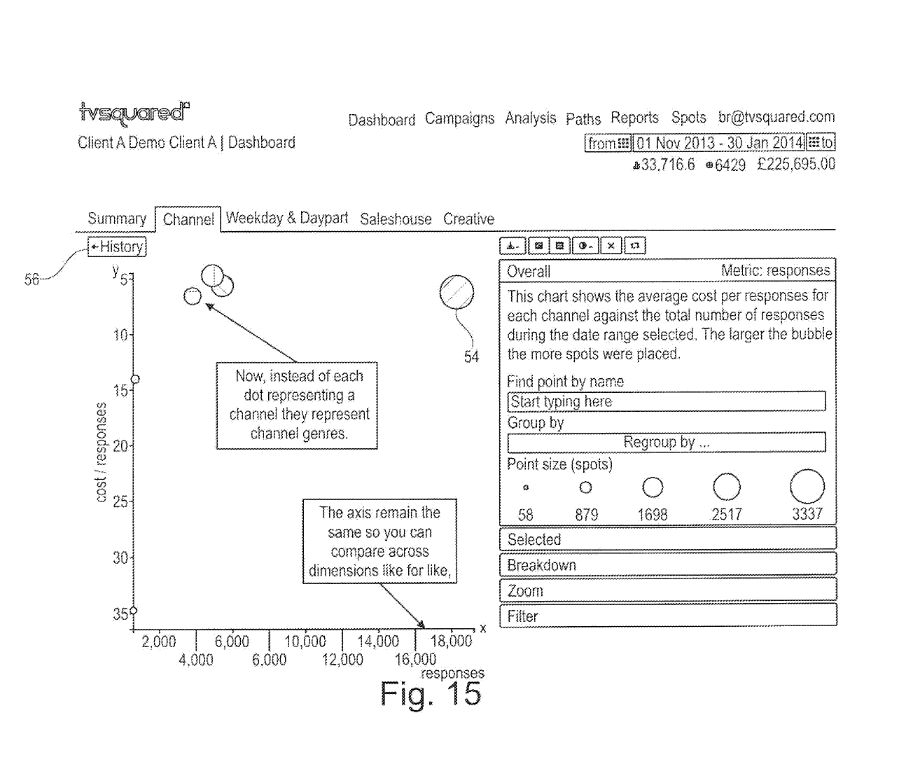

FIGS. 10-15 illustrate examples of the provision of the results to the client in different formats to suit the client requirements.

The invention relates to the fact that in an ideal world all money which is spent on advertising will generate the same level of response value. However in reality the best 10% of spend probably generates 20-40% of the best response and the worst 20-50% of spend only adds 10% of response from users. The present invention therefore provides a system and method which allows an accurate indication of where and when to spend the money on the advertising in order to improve the user response which is achieved from the same.

In accordance with the invention, the analysis of the response data and the provision of useful results to the client or customer can start immediately and, unlike prior art analysis systems, the current invention is not reliant upon a first stage of the analysis of historical data to develop a model which is then used for ongoing analysis. Instead, in the current invention, the analysis of the data is live and changes occur during the ongoing analysis due to live data for user responses at that time rather than relying on historical data. This means that there is no delay in providing the service to new clients or customers. The response data which is collected can, in one embodiment, be split into direct response data 2, diffuse response data 4, which has a greater time lag, deferred response data 6 which has a greater time lag, and brand response data 8 which can be attributed to a brand rather than the predetermined event and this is illustrated in FIG. 1.

The allocation of the collected data into different categories allows the same to be used for different purposes in subsequent analysis. For example the data which is direct response data 2 tends to have a finer granularity 10 and therefore provides a clearer indication of relevance with respect to the particular preceding advert 14 as it can be more clearly allocated to that particular advert rather than one or more earlier adverts At the opposing end of the scale the brand response data 8, which may relate to a user response received some days after the advert in question was shown, has a coarser granularity 12 and can be attributed to the result of the user having viewed a number of the adverts rather than the one particular advert and therefore can be provided as an indication of the effect of an advertising campaign 16 including a plurality of the adverts rather than the effect of one single advert. The finer granularity data 10 can therefore be given greater weight with respect to optimisation of buying of adverts and the impact of clusters of adverts. With regard to the coarser granularity data 12 this can be given greater weight with respect to the deferred responses of users and in the determination of the overall effectiveness of the advertising campaign.

FIGS. 2a-c illustrate the manner in which the collected data of FIG. 1 is processed and, in this case, the collected data is not based on only user response by phone but instead any number of response types can be collected and used as discussed previously. The collected data can include the tracking of user visits to advertisers, user sign-ups to the advertiser and/or user conversions to the advertiser. Furthermore no assumptions of user characteristics or actions are required to be made in the model and no thresholds are required to be set.

The calculated response curves are provided, and a baseline level which is indicative of the level of user response activity which is believed will occur in any case is calculated. The baseline level will change as the analysis progresses over time and to take into account external criteria changes. The collected response data which lies below the baseline level is regarded as representative of general user activity and is not allocated to particular predetermined events. Data processing is then performed for the collected data that remains using, in one example, wavelets to calculate a baseline response level and alter by weighting the response by ratio of collected data from responses via, for example, TV only or TV & internet subscribers. In wavelet analysis the use of a fully scalable modulated “window” at a particular time allows the window to be time shifted and for every position the appropriate baseline value for that time interval is calculated. This movement of the “window” allows new wavelet calculations to be performed and allows the baseline level to be adapted to suit the particular time interval and the collected response data to be suitably assessed at that time interval. For example, more of the received response data may be regarded as general activity data and therefore not allocated to predetermined events in one time interval than that collected in another time interval. Thus there is created a collection of time-scale representations which may have different resolutions and so a multiresolution analysis can be used, and the calculated response baseline levels can be dynamically adjusted and, importantly for many advertisers, the results are available in near-time.

In FIGS. 2a, 3 and 4 the calibration of the collected data is indicated graphically and illustrates in these figures the peak 18 in user responses along the Y-axis with respect to time which is represented along the X axis and therefore clearly shows the peak of user responses with respect to the time of showing a particular advert 20 which is illustrated along the x-axis.

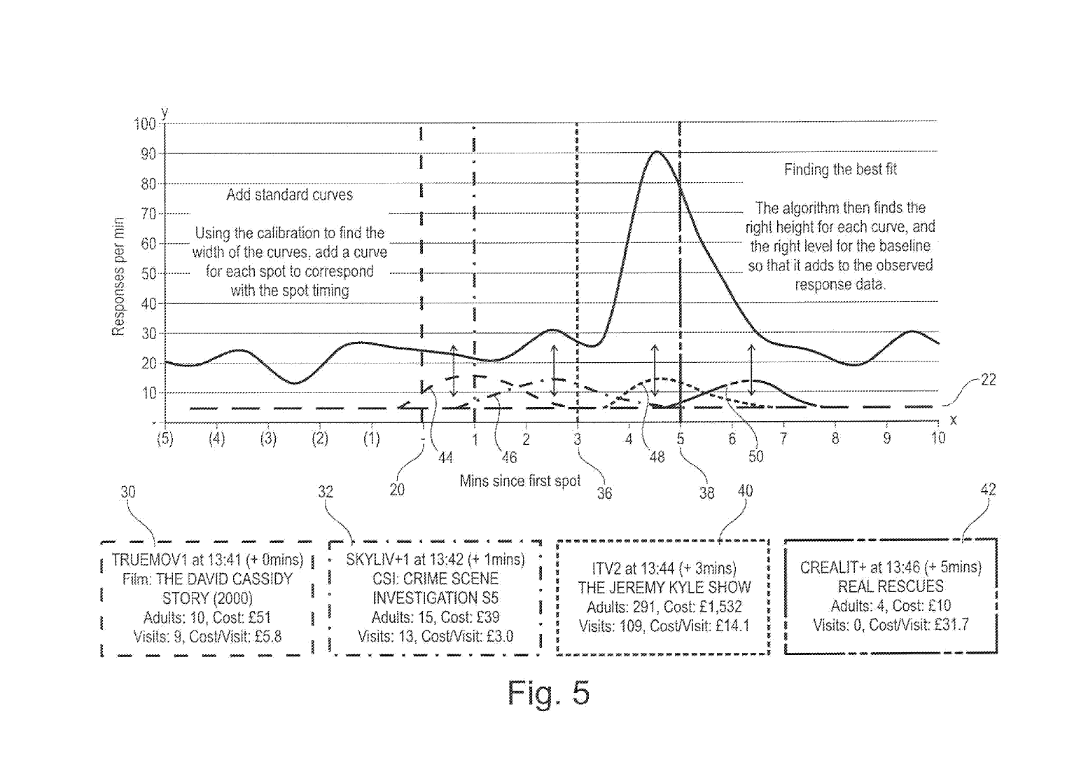

in FIGS. 2b and 5 the attribution process in accordance with the invention is illustrated and in this process the baseline 22 is identified for the user responses and that is the line which is attributed as representing the “normal” level of user response over time which would occur anyway and therefore should not be attributed to the particular advert event 20. The user response data below the base line is removed from consideration and this is the data illustrated in FIG. 2b as being between the baseline 22 and the x axis. This baseline level 22 can be dynamically adjusted with respect to time and/or other known events which may have an effect on the user response other than the advert. It is also shown from a comparison of FIGS. 2a with FIGS. 2b and c that the peak which is attributed to the advert is moved along the time line once the baseline data has been removed.

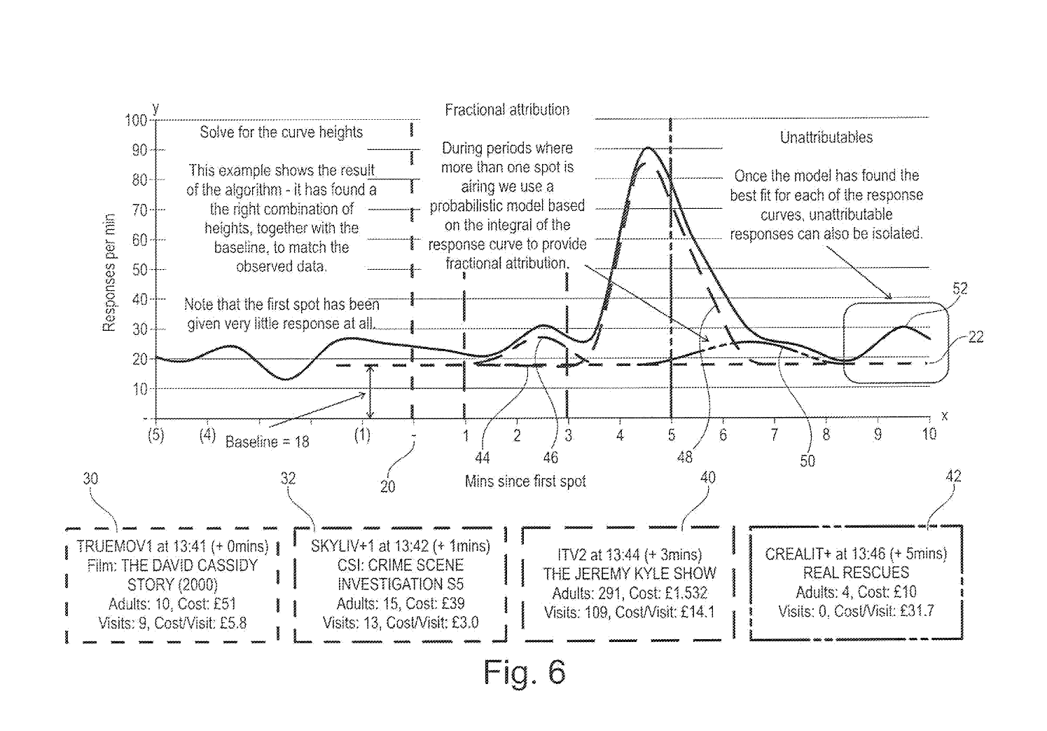

FIGS. 2c and 6 illustrate the manner in which more than one peak 18, 18′ may be identified and in accordance with the invention each peak can be allocated to a particular event, in this case advert 18 linked to an advert appearing on the channel ITV2 and the peak 18′ attributed to an advert which appeared on another channel “Sky1”, which has occurred even if the time of the events overlap or are close together.

As shown in FIG. 3, when identifying the peak 18 and allocating the same with respect to a particular event, such as an advert, the lag 24 between the occurrence 20 of the event and the peak 18 occurring, is taken into account. Furthermore the time for the user response to change from the peak 18 back to the baseline 22 is also taken into account. The model can then be calibrated using best fit data processing techniques in order to change the actual user response curve 26 to the isolated peak response curve 28 which is changed dynamically to take into account other issues, such as the dine the advert was shown, different days of the week and the like.

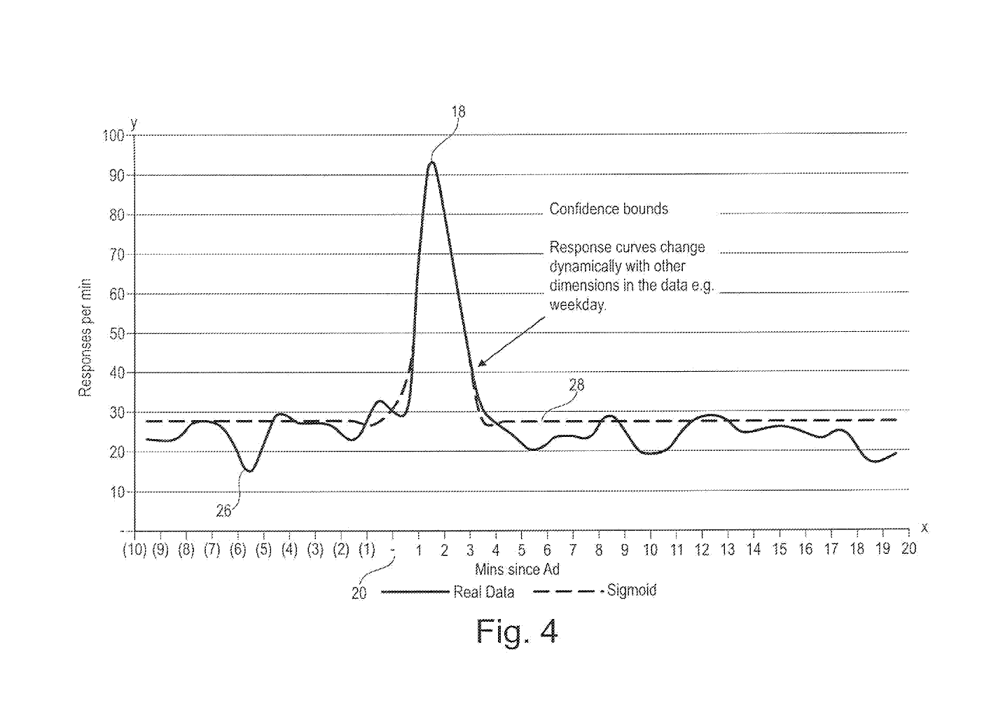

Standard curves may then be added as illustrated in FIG. 5 with the calibration which has been performed in FIG. 4 used to find the width of the curves and to add a curve for each advert to correspond with the advert timing, with, in FIG. 4 the advert 30 occurring at time 20 and response curve 44 is added therefore, the advert 32 occurring at time 34 and the response curve 46 is added therefore, the advert 40 occurring at time 36 and the response curve 48 is added therefore and the advert 42 occurring at time 38 and the response curve 50 is added therefore. The processing used identifies the correct height for each curve and the correct level for the baseline 22 so that this is taken into account with regard to the observed response data.

FIG. 6 illustrates the result of the processing in accordance with the invention in that the correct combination of curve 44,46,48,50 heights is provided along with the correct height of the baseline 22. This example shows the result of the algorithm—it has found the right combination of heights, together with the baseline, to match the observed data.

Note that the curve 44 for the first advert 30 has no significant height increase and therefore is indicated as having relatively little user response effect such that the height of the respective curves illustrates the allocated user response effect of each respective advert. During periods of time where more than one advert is being shown then a probabilistic model based on the integral of the response curve can be used to provide fractional attribution.

In addition, once the model has found the best fit for each of the response curves, unattributable responses such as that indicated at 52 can also be isolated.

In accordance with the invention in one example, and in which due to their high frequency/low intensity nature local cable spots cannot be attributed in the same way as national airings, then, for direct responses which are received, the method steps which are followed include encoding the geographic region boundaries for each event in terms of it's possible area of exposure, and then geo-locating each website visitor using their IP address. The visitors to the advertiser's website are assigned and those visitors who are not connecting from an IP address which is not related to the broadcaster and the identified exposure area in which the advert was placed are filtered out from the collected data.

Data processing is then performed for the collected data that remains using, in one example, wavelets to calculate a baseline response level and alter by weighting the response by ratio of collected data from responses via, for example, TV only or TV & internet subscribers. In wavelet analysis the use of a fully scalable modulated “window” at a particular time allows the window to be time shifted and for every position the appropriate baseline value for that time interval is calculated. This movement of the “window” allows new wavelet calculations to be performed and allows the baseline level to be adapted to suit the particular time interval and the collected response data to be suitably assessed at that time interval. For example, more of the received response data may be regarded as general activity data and therefore not allocated to predetermined events in one time interval than that collected in another time interval. Thus there is created a collection of time-scale representations which may have different resolutions and so a multiresolution analysis can be used

The method then allows for the fractional attribution of the response data which is above the baseline to one or more of the predetermined events.

The method can then be rerun if necessary at different geographical areas and typically with decreasingly less granular levels as the geographical area increases (e.g. DMA local, regional feed split, national).

The invention therefore provides a system and method whereby the information which is available with regard to a particular media event or series of events can be identified, processed and utilised in a significantly more accurate and effective manner than in the prior art systems and methods which are conventionally available.

Referring now to FIGS. 7-9 there are shown method steps for calculating the length of delay between a predetermined event occurring and an order being placed and the ability to allocate the order which has been placed to the particular advert or adverts even after a delay.

The method followed involves the steps of calibrating the data relating to the length of delay between a user's first visit to a particular advertiser's site and when an order is completed for that particular user. Typically therefore this calibration is created for every user upon their visit to the advertiser's site. FIG. 7 therefore illustrates the value of orders which have been made in the y axis and the days since a first visit by users. Typically 95% of orders occur within 7 days of the first visit by the user.

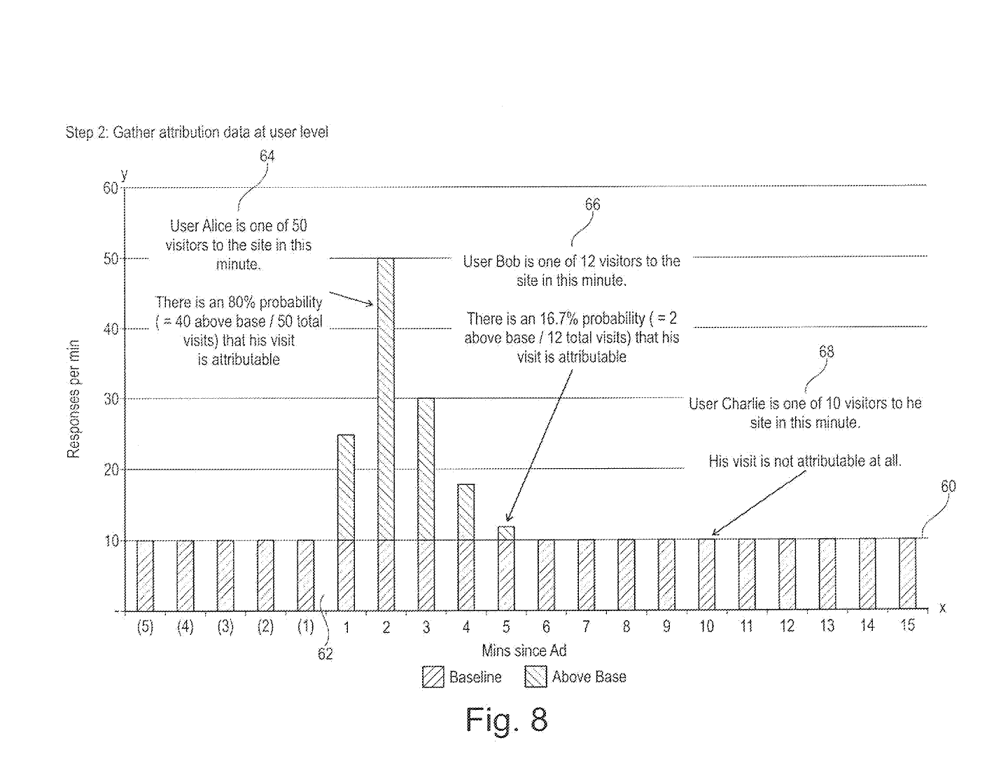

FIG. 8 illustrates the manner in which decisions can be made as to whether detected visits can be attributed to users. The Figure illustrates the baseline 60 at a value of 10 responses per minute and on the x axis there is indicated the number of user visits every minute prior to and following the occurrence of a particular advert 62. In the minutes following the advert there is a surge in visit numbers.

For example, at 2 minutes after the advert there are 50 visitors to the site. Ten of these are deemed to be those that would have occurred anyway as per the baseline value of 10. This therefore means that for each visitor there is an 40/50=80% probability that the visit of each user is attributable to the advert and one of those is a user called Alice 64. At 5 minutes after the advert, there are 12 responses, one of which is a user called Bob 66, and so there is a 16.7% probability (2 visitors above the baseline divided by 12 visitors in total) that the user visit is attributable.

For visits which occur 6 minutes and after, the number of visits is at the baseline 60 so none of the visits by a user is attributable. One of the users who visits at that time is Charlie 68.

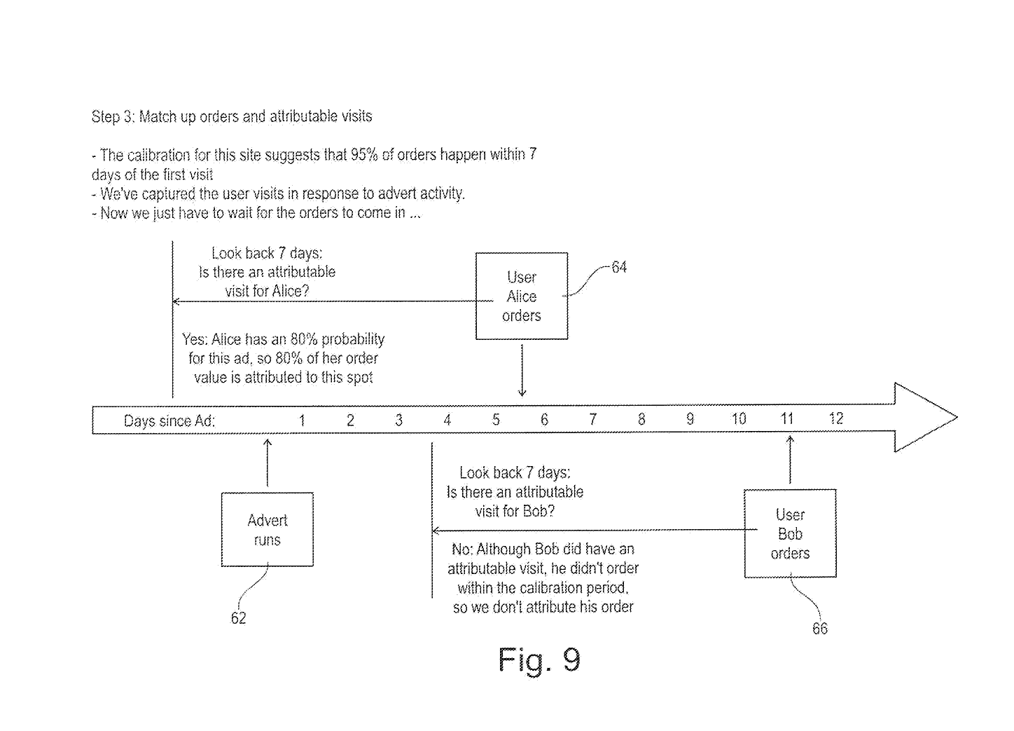

FIG. 9 illustrates the further steps of the method. It is now known from FIG. 7 that the calibration suggests that 95% of orders happen within 7 days of the first user's visit and the user visits in response to the advert are known. Thus when a user places an order such as “Alice” 64 at day 6 after the advert, a search is done back to the time of the advert to check whether Alice made any visits and, if they have, the probability is that the visit was as a result of the advert. In Alice's case there is an 80% probability as calculated at FIG. 8 and thus 80% of her order is attributed to the advert. In the case of Bob 66, he placed an order at day 11 after the advert but, even though he did make a previous visit as discussed in FIG. 8, the order was placed outside the acceptable calibration period of 7 days after the advert so the order is not attributed.

Typically, in order to reduce signal noise and hence improve the possibility of greater accuracy in the analysis, pre and post processing techniques can be used on the data. These can include any, or any combination of, coupon code mapping, multi region mapping, response baseline clean-up, frequency decomposition/calibration, spot synthesis system for delayed response, attribution, session based action, order lag modelling and/or response breakdown modelling can be performed.

FIGS. 10-15 illustrate examples of the provision of the results of the analysis in accordance with the method of the invention to clients or customers. It will be seen from FIG. 10 that the data can be provided in the form of a summary dashboard to provide information to a client of the analysis of all of the predetermined events, such as adverts which they have placed in a given time period.

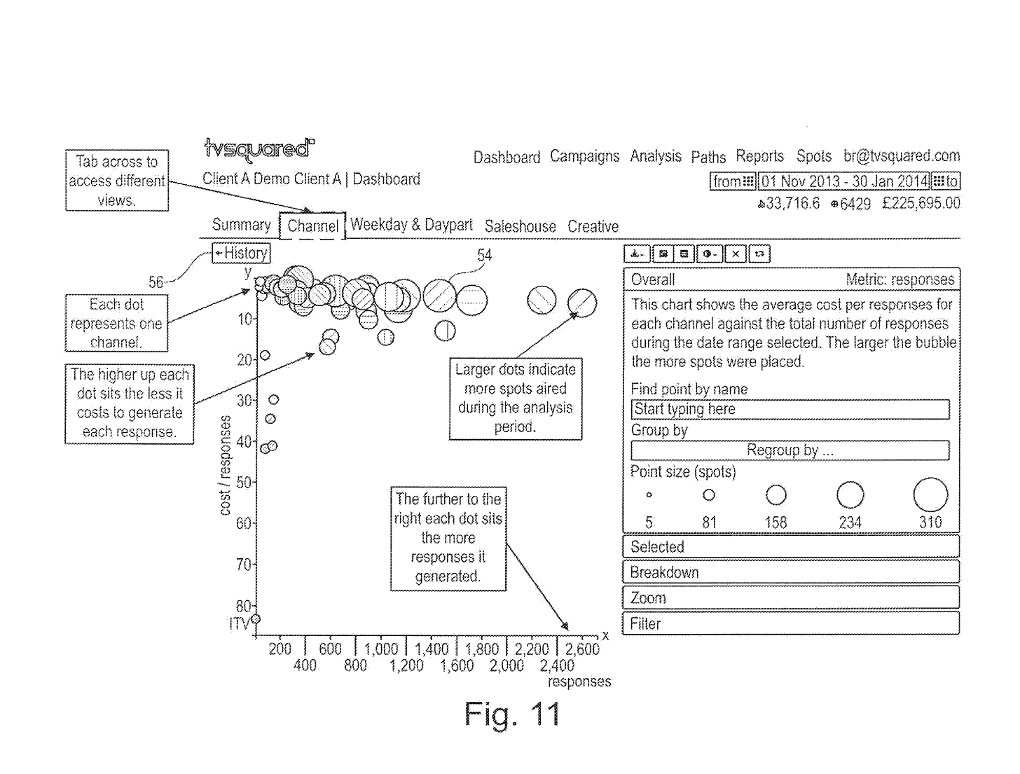

FIGS. 11-15 illustrate graphical representations in which the x axis can be selected to relate to the number of responses, or revenue generated and the y axis can be selected to represent the cost per response or cost per revenue to the client. Within the graph there are provided a number of “dots” 54, with each of the dots representing a TV channel, programme, genre or any of a range of options. The position of each of the dots is selected to represent the user response activity and/or revenue activity and so the relative positioning of the dots gives the client an immediate indication of how an advert represented by each dot 54 has performed with respect to the adverts represented by the other dots 54, or indeed can indicate any other relative analysis between the respective dots as required by the client. Furthermore, the relative size of the dots 54 provides an indication of the advert performance such that, for example, the greater the size of the dot then the greater the number of adverts placed in the time period to which the analysis relates.

Access can also be gained to historical analysis 56 and the level to which the analysis is broken down in terms of detail can also be selected by the client.

It will therefore be appreciated that the invention provides a unique method of collection and analysis of user response data in relation to predetermined events and, as a consequence of this, a significantly improved collection of results data for use by the client.

1. A method of utilising data relating to one or more predetermined events which occur in at least one visual and/or audible media, said system comprising means for collecting data from one or more sources relating to one or more users, allocating the data which has been collected, to predefined times or time intervals, storing data indicating the occurrence of the predefined events in terms of any, or any combination, of time, said media location for the display of the predefined event and/or geographical accessibility of the predefined event and wherein the collected data is selectively attributed to the one or more predetermined events and processing means allow the classification of that of the collected data which is identified as not being attributable to the said predetermined event by analysis of the collected data in combination with the stored data.

2. A method according to claim 1 wherein the processing means takes into account the time lag between the occurrence of the predetermined event, and the data potentially relating thereto being collected.

3. A method according to claim 2 wherein the strength of correlation between the predetermined event and a portion of the said data increases as the time lag reduces.

4. A method according to claim 1 wherein a calculation is performed as to the probability that the said collected data is resultant from a predetermined event.

5. A. method according to claim 1 wherein the data relating to the predetermined event is collected and then filtered using, one or a combination of filtering techniques.

6. A method according to claim 5 wherein a filter step is performed on the collected data to remove from consideration at least some of the data which is a result of an occurrence independent of the said predetermined event.

7. A method according to claim 1 wherein a filter step is performed on the collected data at a first level of granularity.

8. A method according to claim 7 wherein a further filtering step or steps is/are performed which is of a greater degree of granularity than the first in order to allocate the collected data to at least on predetermined event from a number of the predetermined events which have occurred within a given time period.

9. A method according to claim 8 wherein the filtering is performed in order to identify and allocate the collected data with respect to a plurality of predetermined events.

10. A method according to claim 8 wherein the allocation includes the step of analysing audience ratings data.

11. A method according to claim 1 wherein the collected data is from users who perform a particular action in association with the organisation with which the predetermined event is connected.

12. A method according to claim 1 wherein the said predetermined event occurs via a first service and the collected data is collected via a second service which differs from the first service.

13. A method according to claim 1 wherein the collected data is obtained from a known and partitioned portion of users.

14. A method according to claim 13 wherein the collected data is processed with respect to the partitioned portion in a first instance, and filtered to identify correlations between the data and the occurrence of the predetermined events in the partitioned portion.

15. A method according to claim 1 wherein the collected data for a plurality of partitioned portions and the predetermined events which have occurred therein, are combined into collected data groups to form a larger partitioned portion.

16. A method according to claim 15 wherein the type and/or granularity of the filtering steps which are preformed is changed with respect to the size and/or particular partitioned portion size for which the collected data is to be processed.

17. A method according to claim 12 wherein a relatively finer granularity of filtering is used for collected data for smaller partitioned portions than is used in larger partitioned portions.

18. A method according to claim 13 wherein the partitioned portion is a geographical area in which the users from which the data is collected are located.

19. A method according to claim 2 wherein the time lag for the collected response data occurring may vary depending on the client type, brand type, product and/or product type to which the predetermined event relates.

20. A method according to claim 2 wherein the time lag for the collected response data occurring may vary depending on the type of media and/or device which is used by the user to make the response.

21. A method according to claim 1 wherein the collected response data is split into direct response data, diffuse response data which has a greater time lag, deferred response data which has a greater time lag, and brand response data which can be attributed to a brand rather than a particular predetermined event.

22. A method according to claim 1 wherein a base line is created which is indicative of the level of the collected data which is indicative of general activity and is not attributed to the said predetermined event.

23. A method according to claim 22 wherein the has-tine value is adaptable over time.

24. A method according to chap 23 wherein the adaptation is in response to the pattern of user response and/or occurrence of external events relating to the product or service to which the predetermined event relates.

25. A method according to claim 1 wherein the data which is collected includes an or combination of user purchase of a product, user selection of a particular option to access an internet site, phone access via one or more numbers, a smartphone application, physical purchase by a user, and/or a user response of an expression of interest.

26. A method according to claim 2 wherein the predetermined event is an event which appears in a television or radio channel.

27. A method according to claim 26 wherein the said event is an advertisement for product or service, or public service announcement.

28. A system of utilising data relating to one or more advertising events which occur in at least one visual and/or audible media, said system comprising means for collecting data from or more user sources sand allocating the data which has been collected, to response times and/or a time interval after a particular predetermined event, storage means for the storage of said collected data and allocation data and data relating to the occurrence of the predetermined events in terms of any, or am combination, of time, said media location for the display of the predefined event and/or geographical accessibility and wherein processing means are provided to attribute that collected data which can be attributed to one or more predefined events and said processing means include filtering means to remove collected data which is not attributable to said advertising event.

29. Apparatus for utilising data relating to one or more predetermined events which occur in at least one visual and/or audible media, said apparatus including communication means to receive data relating to the said predetermined events from a plurality of user sources, processing means which allocate, with reference to at least one parameter of the said collected data, the collected data to response times and/or a time interval after a particular predetermined event, storage means for the storage of said collected and allocation data and for data relating to one or more predetermined events in relation to any, or any combination, of, time of the predetermined event, the location of the display of the predetermined event in said media and/or the geographical accessibility of the predetermined event and wherein the processing means attributes at least part of the collected data to a particular one of the one or more predetermined events and filtering means are provided to remove collected data which is not attributed to said predetermined event.
